(19) United States
(12) Patent Application Publication
(10) Pub. No.: US 2002/0066522 A1
(43) Pub. Date: Jun. 6, 2002

(54) PLASTIC FILM WITH MINERAL ADDITIVES, METHOD FOR THE PRODUCTION AND USE THEREOF

(76) Inventors: AXEL NICKEL, PEINE (DE); STEFAN ETZOLD, LANGENHAGEN (DE)

Correspondence Address: COLLARD & ROE, 1077 NORTHERN BOULEVARD, ROSLYN, NY, 11576

(21) Appl. No.: 09/380,328

(22) PCT Filed: Mar. 4, 1998
(86) PCT No.: PCT/DE98/00641

(30) Foreign Application Priority Data
Mar. 7, 1997 (DE) 197 09 352.3

(51) Int. Cl. B32B 5/00

(52) U.S. Cl. 156/229; 156/244.24; 264/288.8

(57) ABSTRACT

The invention relates to a film made of plastic having at least one mineral additive, wherein capillaries are formed through expansion at phase transition limits between the plastic and the mineral additives. Said film forms a laminate in conjunction with a plastic non-woven fabric, the laminate remaining in an expanded state. The plastic film and non-woven fabric materials display the same or substantially similar plastic expansion characteristics.

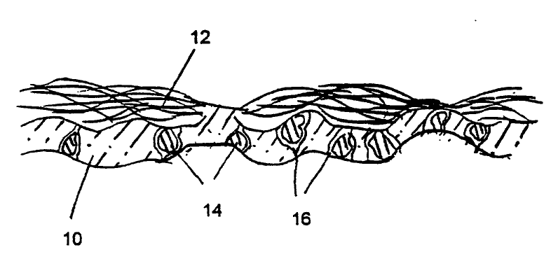

The invention relates to a film made of plastic with mineral additives, and to a method for the production thereof, as well as to a use of the film.

Films with mineral additives are known in order to obtain porous properties. The porosity is produced in that when the film is extended, phase transition limits between the plastic material and the mineral additives tear open, forming capillaries in this way.

So that the capillaries can form in the desired way, the plastic material has to be plastic but nonetheless offer a certain toughness. Furthermore, the film is required to have a low thickness, so that the capillaries are capable of extending also from one side of the film to the other. Such films have only low mechanical strength because versus a pure plastic film which, compared to fibrous materials, has a low strength to begin with, embedding of the mineral additives with the tendency to tearing the film open on the phase transition limits, leads to further weakening of the mechanical strength.

The invention is based on the problem of improving a film and a method for its production in such a way that the mechanical strength is significantly increased, as well as of specifying an application for such a film.

Said problem is solved with a film according to the introductory part of claim 1, and with a methods for its production according to the introductory part of claim 10, and with an application according to the introductory parts of claims 13 and 14, by the features specified in the respective characterizing parts of said claims.

Substantial improvement of the mechanical strength of the film is achieved by the laminate made of fleece and film, whereby the more favorable mechanical properties of a fiber structure are jointly exploited as well. The identical or approximately identical expansion properties of the fleece and the film assure that the composite of fleece and film remains preserved even after the required stretching, i.e., detachment on the stamping marks or tearing of the fibers or film are avoided. Since the fibers of the fleece crystallize when stretched, their strength is increased by the expansion process required for forming the capillaroes.

In spite of the plastic properties of the fleece and film materials, low resetting forces ensue after the expansion process, which lead to swelling and pleating of the film between the stamping marks. Said pleats represent predetermined buckling points, which has the positive effect that creasing noise is avoided as compared to conventional film materials, or substantially dampened. Furthermore, the nature of a textile material is obtained owing to the fleece, which has positive effects both visually and under the aspects of touch and skin compatibility. Swelling of the film changes its surface structure in a positive way and also contributes to the enlargement of the volume. Since textile materials are basically permeable to liquids, the property of active breathing of the film is not impaired by combining it with the fleece.

The breathing properties of the laminate can be changed by varying degrees of expansion. The laminate so obtained can be applied in the hygienic and medical fields as well as in the construction sector.

In a first embodiment, the laminate consists of a layer of film and a layer of fleece and has an area weight of less than 20 grams per square meter. This produces a laminate which is very light and thin, so that the stiffness of the laminate can be kept low. Furthermore, with such an area weight, the laminate can be used in many different ways due to its low thickness, for example for diapers or for refining textiles. The suitable area expansion factor amounts to 2 to 3.5. This results in very good active breathing properties.

In a second embodiment, the laminate consists of a layer of film and two layers of fleece, which are arranged on both sides of the layer of film. Said laminate has an area weight of 50 to 100 g, preferably 80 g per square meter. Said material is particularly stable and tear-resistant. The suitable area expansion factor amounts to 1.5 to 2.5. Said value provides for good properties of active breathing.

Polyethylene and polypropylene as well as copolymers are suitable as basic plastic materials. Considerable mineral additives are, for example barium sulfate, calcium carbonate, or silicates. Said substances were found to be suitable for providing for controlled tearing of the film at the phase transition points between mineral substances and plastics. Furthermore, said substances are harmless under the aspect of health.

In the process for producing a laminate from a film and a fleece, said materials can first be produced separately and intermediately stored, and they can be manufactured jointly, combined, and fixed by means of a thermal stamping process with the help of calender rolls. Alternatively, the film and the fleece can be joined also by gluing. The laminate is subsequently expanded as required for obtaining the desired pore size.

It may be advantageous if in the course of the manufacturing process, the film is directly joined in the molten phase with the fleece with application of mechanical, aerodynamic or electrostatic forces.

A film in the form of a laminate with a layer of fleece and with an area weight of less than 20 grams per square meter, as well as with an area expansion factor between 2 and 3.5 can be employed as the outer skin of a diaper, a surgical cloth, or as a cover cloth. Such application is favorably influenced by the low area weight combined with high stability, as well as by its tightness versus water, but high permeability to water vapor, and by the properties of active breathing. In addition, the laminate is tight versus bacteria or viruses.

A film in the form of a laminate with two layers of fleece and with an area weight of between 50 and 100 g per square meter as well as with an area expansion factor of between 1.5 and 2.5 can be employed as a web installed beneath roof structures. The two layers of fleece provide for particularly high stability in such an application. Tightness to water is assured at the same time, combined, however, with permeability to water vapors.

The invention is explained in greater detail in the following with the help of the drawing, which schematically shows a section through a laminate as defined by the invention.

The drawing shows a laminate with a film 10 and a fleece 12. The film 10 consists of polyethylene or polypropylene with mineral additives 14. Film 10 may be produced in this connection by a film drawing process which is known per se, whereby plastic serves as the basic material, which was mixed with mineral additives. Fleece 12 may be produced by a spun fleece process or by a melt blowing process.

After having been placed one on top of the other, fleece 12 and film 10 are joined by a thermal stamping process with calender rolls and subsequently expanded. The expansion causes tearing of the phase transition limits between the embeddings of the mineral additives and the plastic, whereby the capillaries 16 are formed. Said capillaries 16 have the property that they only permit the passage of atomic substances, whereas they block substances consisting of larger molecular structures.

1. A film made of plastic with at least one mineral additive (14), in which capillaries are formed by expansion on the phase transition limits between the plastic and mineral additives, characterized in that the film (10) and a fleece (12) made of plastic jointly form a laminate and the laminate is permanently expanded, whereby the plastic materials of the film (10) and the fleece (12) have the same or substantially similar plastic expansion characteristics.

2. The film according to claim 1, characterized in that the laminate consists of a film layer (10) and a fleece layer (12) and that it has an area weight of less than 20 grams per square meter.

3. The film according to claim 1 or 2, characterized in that the area expansion factor amounts to from 2 to 3.5.

4. The film according to claim 1, characterized in that the laminate consists of one film layer (10) and two fleece layers (12) arranged on both sides of the foil layer (10), and that it has an area weight of 50 to 100 g, preferably 80 g per square meter.

5. The film according to claim 1 or 2, characterized in that the area expansion factor amounts to 1.5 to 2.5.

6. The film according to any one of claims 1 to 5, characterized in that the plastic material of the foil (10) and the fleece (12) is polyethylene or polypropylene.

7. The film according to any one of claims 1 to 6, characterized in that the mineral substance (14) is barium sulfate.

8. The film according to any one of claims 1 to 7, characterized in that the mineral substance (14) is calcium carbonate.

9. The film according to any one of claims 1 to 8, characterized in that the mineral substance (14) is a silicate.

10. A method of producing a film from plastic with at least one mineral additive, in which capillaries are formed by expansion on the phase transition limits between the plastic and the mineral additives, characterized in that a laminate is formed from the film and a fleece and the laminate is subsequently expanded, so that the film and the fleece are permanently stretched.

11. The method according to claim 10, characterized in that the film and the fleece are first produced separately or jointly and the layers of film and fleece are subsequently placed one on top of the other and joined by a thermal stamping process or by gluing.

12. The method according to claim 10 or 11, characterized in that in the course of the manufacturing process, the film is directly joined in the molten phase with the fleece with application of mechanical, aerodynamic or electrostatic forces.

13. The use of a film with the features of claim 2 or 3, characterized in that the film is employed as the outer skin of a diaper, as a surgical cloth or a cover cloth.

14. The use of a film with the features of claim 4 or 5, characterized in that the film is employed as a web installed below roof structures.
